(19) United States
(12) Patent Application Publication
(10) Pub. No.: US 2015/0218847 A1
(43) Pub. Date: Aug. 6, 2015

(54) SHEET MATERIAL CORNER REINFORCEMENT

(71) Applicant: Extenday IP Limited, Auckland (NZ)

(72) Inventor: Jonathan Dallas Toye, Auckland (NZ)

(21) Appl. No.: 14/610,952

(22) Filed: Jan. 30, 2015

(30) Foreign Application Priority Data
Jan. 31, 2014 (NZ) 620601

(51) Int. Cl. E04H 15/64; B32B 3/08; B32B 7/08; B32B 3/06

(52) U.S. Cl. CPC E04H 15/64; B32B 3/06; B32B 3/08; B32B 7/08

(57) ABSTRACT

A reinforcement structure for securement to a corner of a sheet material is described. The reinforcement structure comprises a first plate member and a second plate member each having an overlapping portion and an aperture disposed within the overlapping portion. The apertures are coaxially aligned to accept a fastener at an axis on which the first and/or second plate members are rotatable to extend along adjacent edges of the sheet material in use.

### PRIORITY CLAIM

This invention claims priority from New Zealand Application Serial No. 620601 filed Jan. 31, 2014, which is hereby incorporated by reference.

### FIELD OF THE INVENTION

The invention relates to a sheet material attachment means and in particular to a corner reinforcement structure for a sheet material.

### BACKGROUND OF THE INVENTION

Sheet material is useful as netting that is deployed over vegetation such as trees within a plantation or orchard. For example, sheet material may be deployed to protect fruit from birds or to exclude bees from pollinating fruit when seedless fruit is required, or to protect vegetation from weather conditions such as overly bright sunlight, or hail or a fabric material to exclude rain fall from the fruit. The material may be, for example, a netting or cloth-like material and is typically stored in a roll such that it can be deployed when required by unravelling and draping. Other types of sheet material are useful as ground covering to prevent unwanted growth of weeds or plants in an orchard or garden.

Such sheet material is typically anchored in place once deployed to prevent wind movement. Anchoring is typically performed by passing an anchoring device through an anchoring aperture in the sheet material and into an anchoring point. For example, ground covering material may be pegged in place. Pulling or dragging forces applied to the sheet material can cause unwanted rupturing or tearing of the material. To address this problem, reinforcement can be applied to the sheet material surrounding the anchoring aperture to spread forces from the anchor away from the aperture and over a larger span of material. By spreading forces away from the anchoring aperture the material can withstand higher forces before any breakdown of the material occurs. However, corner reinforcement structures of the prior art lack versatility in that they cannot be applied to a wide range of sheet material corners.

The present invention provides a corner reinforcement structure which overcomes or ameliorates the abovementioned disadvantages, or which at least provides the public with a useful choice.

### SUMMARY OF THE INVENTION

In one aspect, the present invention consists in a reinforcement structure for securement to a corner of a sheet material comprising a first plate member and a second plate member each having an overlapping portion and an aperture disposed within the overlapping portion, wherein the apertures are coaxially aligned to accept a fastener at an axis on which the first and/or second plate members are rotatable to extend along adjacent edges of the sheet material in use.

In some embodiments the first plate member comprises an axially extending annular lip coaxial with the aperture of the first plate member, the lip extending at least partially into the axially aligned aperture of the second plate member.

In some embodiments each plate comprises an upper plate and a lower plate and a slot there between for receiving the sheet material.

In some embodiments the fastener is a grommet or rivet, in use the grommet or rivet extending through each aperture to define a pivot about which the first or second plate rotates to meet adjacent edges of the sheet material.

In some embodiments the first and/or second plate members are rotatable to define an angle between them in the range of 0 degrees and 180 degrees.

In some embodiments the second plate member is rotatable on the lip relative to the first plate member.

In some embodiments the upper plate and the lower plate each comprise a said aperture, the apertures in the upper and lower plates coaxially aligned.

In some embodiments the first plate member comprises an axially extending annular lip extending from the upper plate coaxial with the aperture of the upper plate, the lip received in the aperture of the upper plate of the second plate member, and the second plate member comprises an axially extending annular lip extending from the lower plate coaxial with the aperture of the lower plate, the lip received in the aperture of the lower plate of the second plate member.

In some embodiments the annular lip of the first plate member extends upwards from the upper plate first plate member, and the annular lip of the second plate member extends downwards from the bottom plate of the second plate member.

In some embodiments the first and second plate members are identical, one of the first and second plate members being oriented upside-down relative to the other one of the first and second plate members so that the first and second plate members fit or assemble together.

In some embodiments the upper and lower plates of each of the first and second plate members are spaced apart by a backing wall, in use the backing wall abutting an edge of the sheet material.

In some embodiments the overlapping portion comprises a curved end, the upper and lower plate members each have a curved end in the overlapping portion, the curved end having a center of curvature at a center of the aperture.

In some embodiments the first or second plate members, or both, have a second aperture positioned at or towards an end opposite to the overlapping portion.

In another aspect, the present invention consists in a sheet material with a reinforcement structure at a corner of the sheet material, the reinforcement structure comprising a first and a second plate member each having an overlapping portion and an aperture disposed in the overlapping portion, the apertures positioned in coaxial alignment, and a fastener that extends through the apertures and the sheet material, the first and second plate members rotatable about an axis through the apertures so that the first and second plate are positioned along edges of the sheet material that meet at the corner of the sheet material.

In some embodiments the fastener is a grommet or rivet.

A sheet material may comprise a reinforcing structure as described in any one or more above statements.

In another aspect, the present invention consists in a plate member for use in construction of a reinforcement structure adapted for securement to a corner of sheet material comprising an aperture for coaxial configuration with an aperture of another elongate member, the aperture adapted to accept a fastener that extends through each coaxially aligned aperture at an axis about which the plate member can rotate relative to another plate member.

In some embodiments the plate member comprises an upper plate and a lower plate and a slit there between for receiving the sheet material.

In some embodiments the upper and lower plates are spaced apart by a backing wall, in use the backing wall abutting an edge of the sheet material.

In some embodiments the plate member comprises an axially extending lip coaxial with the aperture, the lip adapted to extend, at least partially, into the aperture of another axially aligned plate member.

In some embodiments the plate member has a curved end, the curved end having a center of curvature at a center of the aperture.

In another aspect, the present invention consists in a method of attaching a corner reinforcement structure to a sheet material comprising providing the reinforcement structure as described in the statements above, providing a sheet material having a corner with a corner angle between 0 and 180 degrees, positioning the first plate member to meet one edge of the corner of the sheet material, positioning the second plate member to meet a second edge of the corner of the sheet material by rotation relative to the first plate member on an axis through the coaxial apertures of the first and second plate members, attaching the reinforcement structure to the sheet material using one or more fasteners.

The following embodiments may relate to any of the above aspects. Other aspects of the invention may become apparent from the following description which is given by way of example only and with reference to the accompanying drawings.

As used herein “(s)” following a noun means the plural and/or singular forms of the noun. The term “and/or” means “and” or “or”, or both. The term “comprising” as used in this specification means “consisting at least in part of.” When interpreting statements in this specification which include that term, the features, prefaced by that term in each statement or claim, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1 shows a perspective view of a plate according to embodiments of the invention.

FIG. 2 shows a top view of the plate of FIG. 1.

FIG. 3 shows a bottom view of the plate of FIGS. 1 and 2.

FIG. 4 shows a first and second plate configured to match a corner angle of approximately 180 degrees.

FIG. 5 shows the first and second plate of FIG. 4 configured to match a corner angle of approximately 90 degrees.

FIG. 6 shows the first and second plate of FIGS. 4 and 5 configured to match a corner angle of approximately 10 degrees.

FIG. 7 illustrates the movement range of the plate sections according to various embodiments of the invention.

FIG. 8 shows an end view of the plate of the FIGS. 1 to 7.

FIG. 9 illustrates a sheet material that is a canopy comprising a reinforcing member according to some embodiments of the present invention.

### DETAILED DESCRIPTION

The invention relates to a reinforcement structure for securement to a corner of a sheet material.

Structures in the prior art have addressed the issue of improving the stability of apertures in sheet material somewhat, however such structures lack versatility in that they are fixed to a predetermined corner angle and therefore useful only for a corner of sheet material that agrees with that angle. The invention is a more versatile reinforcement structure with applications to a wide range of corner angles that may span, for example, between 10 and 180 degrees.

FIG. 1 shows a plate member 10 that accords with various embodiments. The plate member 10 is an elongate structure that comprises spaced apart upper 12 and lower 13 plates with a backing surface or wall 14 that spans between the upper and lower plates. A slit or slot 15 is defined by the space between the upper plate 12 and lower plate 14. In alternative embodiments the plate member has only an upper plate and no lower plate or vice versa. In some embodiments the plate member may have an upper plate and a backing wall and no lower plate or vice versa.

In the embodiment shown the slit 15 provides a space where the sheet material is positioned so that the upper and lower plates envelope an edge portion of the sheet material. The backing wall 14 forms a locating surface for the edge of the sheet material when positioned in the slit or slot 14.

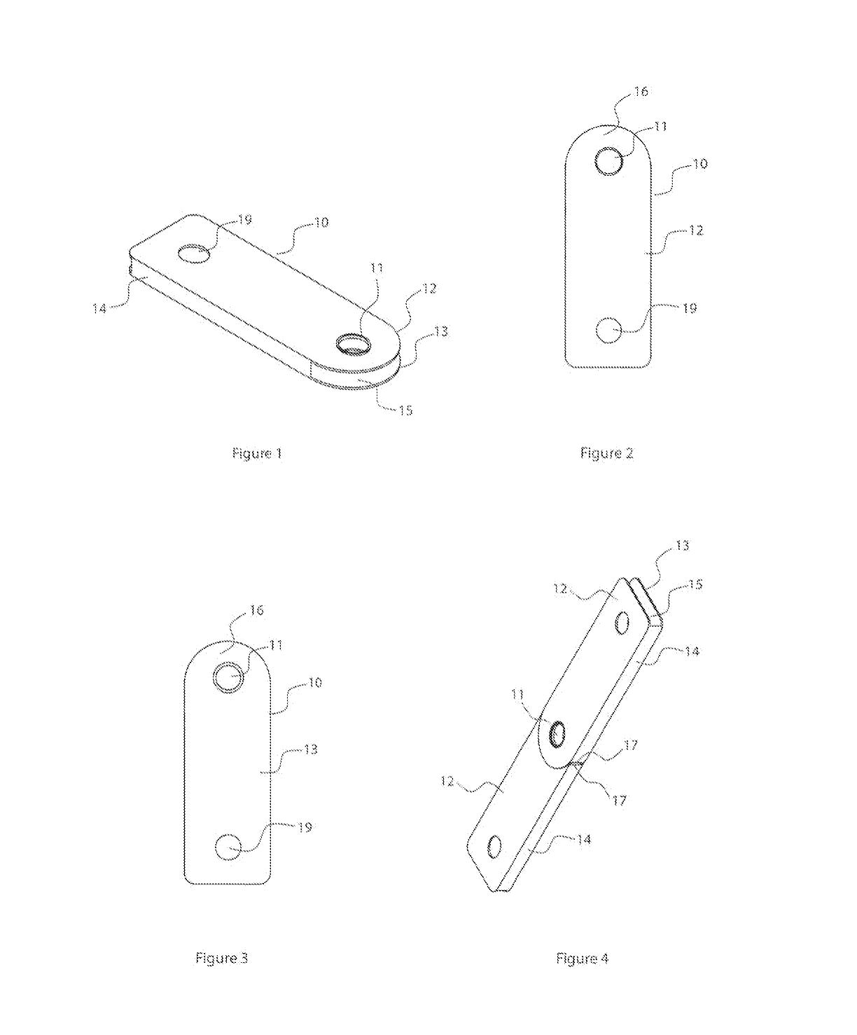

The plate 10 further comprises an aperture 11 located near or towards one end. In some embodiments, the aperture 11 extends through both the upper and lower plates. That is the upper plate and the lower plate each have an aperture 11, the aperture of the upper plate coaxial with the aperture of the lower plate. For example, the embodiment shown in FIG. 2 and FIG. 3.

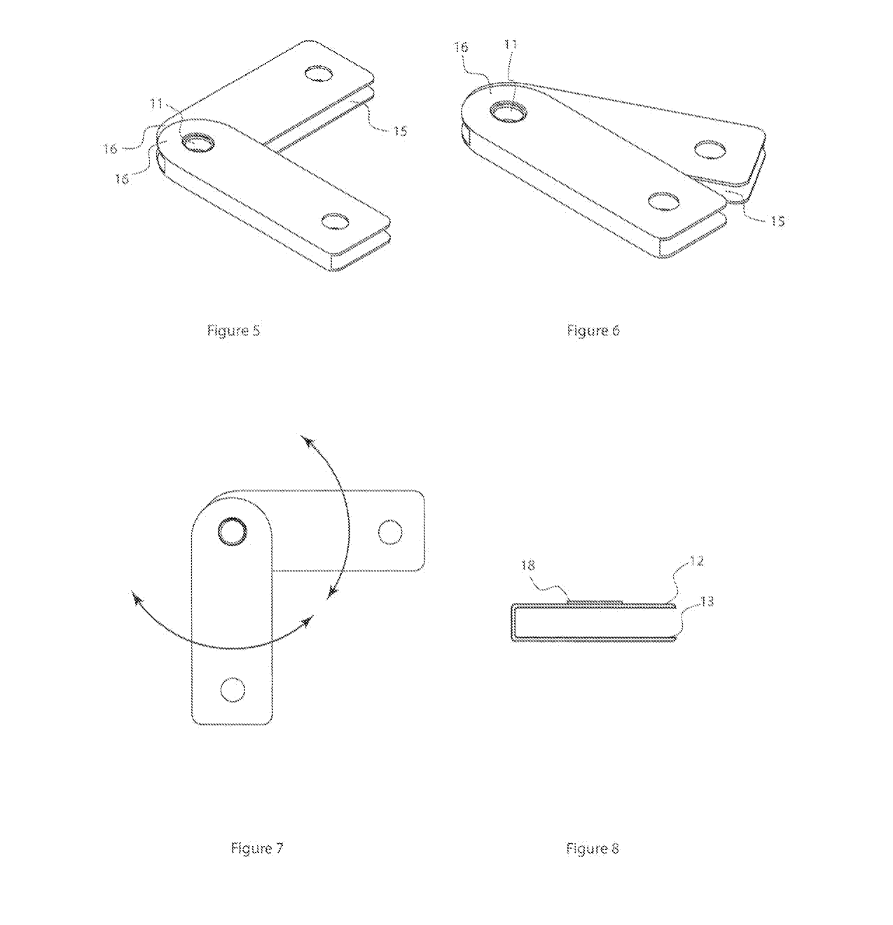

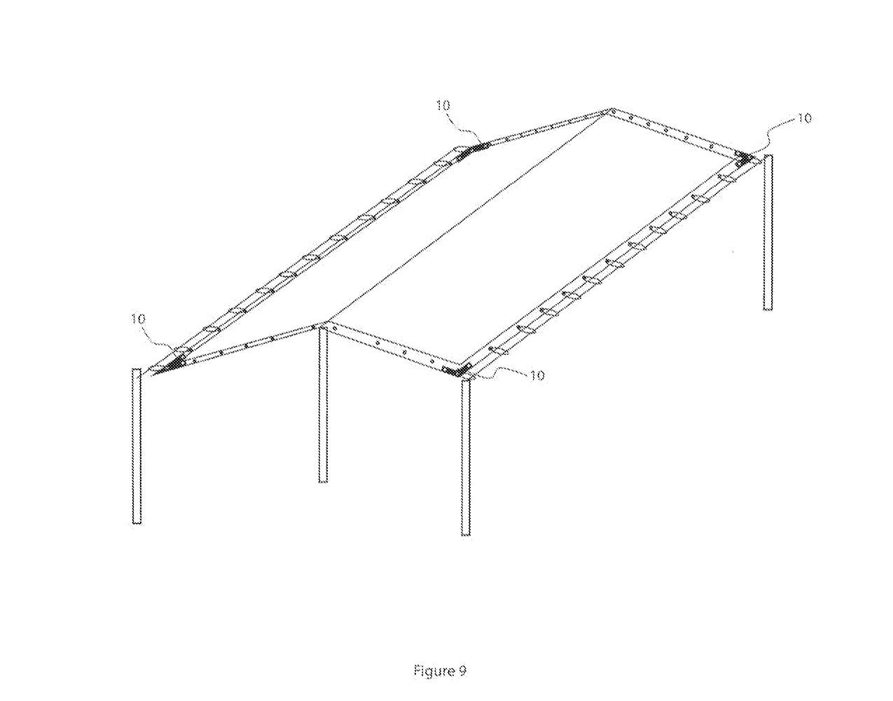

The plate 10 is used in conjunction with at least one other same or similar plate to form a corner reinforcement structure for a sheet material. A particular embodiment is shown in FIGS. 4 to 6 where two plates are overlapped about their respective apertures 11 which are axially aligned. The axially aligned apertures 11 form a point where the two plates can pivot or rotate so that the slit 15 defined between the upper 12 and lower 13 plates can envelope the corner of a sheet material with a variety of corner angles.

For example, the embodiment shown in FIG. 4, the plates are overlapped and rotated to form a reinforcement structure for a corner of approximately 180 degrees. Similarly, FIG. 5 shows plates overlapped and rotated to form a reinforcement structure for a corner of approximately 90 degrees and FIG. 6 shows plates that are overlapped and rotated to form a reinforcement structure for a corner of approximately 10 degrees. Those skilled in the art will appreciate that the reinforcement structure could be adjusted by pivoting one or both plates to meet any angle within the range of 0 to 180 degrees such as shown in FIG. 7. Preferably the two plate members 1 are interleaved, that is, the upper plate of a first plate member sits above the upper plate of the second plate member, and the lower plate of the first plate member sits above the lower plate of the second plate member.

To facilitate overlap and an uninhibited ability to rotate, each end portion of the plate members 10 comprises a curved outer end 16 that substantially follows the radius of the aperture 11 at the outer end of the plate. The curved portions 16 ensure that the abutting edges 17 of the backing wall 14, as shown in detail in FIG. 4, are spaced far enough apart that wide span angles between the plates can be achieved. Those skilled in the art will appreciate that shapes or contours in the end portion of each plate could vary in numerous ways to provide space for uninhibited rotation.

In some embodiments, the aperture 11 in each plate 10 comprises a raised lip that extends from either the upper or lower plate or both. FIG. 8 shows a side view of a plate where a lip 18 extends axially and outward from the plate surface at periphery of the aperture 11 such that a pivot is formed. In such embodiments, the lip 18 extends within the periphery of another plate aperture 11 to rotatably position the two plates together. Alternatively, a feedback mechanism is provided by the snapping into place of the plates which indicates in use that two plates are substantially aligned and can be rotated about the apertures. Those skilled in the art will appreciate that the material must be somewhat resilient to allow the deformation of the plates so the apertures may be aligned.

In use the corner reinforcement structure is attached to the corner of a sheet material by rotating one plate to meet one side of the sheet material that extends from a corner and rotating a second plate to meet the second side of the sheet material extending from the same corner. The sheet material should reside within the space of the slit created by the upper and lower plates of the plate member 10. A fastener is passed through the axially aligned apertures of the two plates and through an aperture in the sheet material. The aperture in the sheet material may be preformed or alternatively the fastener may be tasked with puncturing the sheet material as it passes through the apertures. The fastener may be a grommet or rivet or any other similar device. In some embodiments the fastener provides a rotational support about which one or both plates can rotate about. However in other embodiments the fastener merely resides within the aperture without providing support to the rotating plates. The fastener extending through the apertures 11 of plate members 10 may also hold or fix the two plate members together to prevent relative movement between the two plate members and/or the sheet material. In some embodiments each plate 10 further comprises one or more other mounting holes 19 that are adapted to allow further fastener such as a grommet or rivet to pass through thereby provide further attachment points between sheet material and the reinforcement structure. Further mounting holes and fasteners act to improve the load spreading ability of the corner reinforcement structure. In other embodiments, fasteners may be replaced with adhesive compounds.

The upper and lower plate members 10 may be formed from metal, for example folded from sheet metal or may be an extrusion, for example an Aluminum extrusion. In a preferred embodiment the plate members are molded from a plastics material. The plate members may be formed from any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA) and ethylene methyl acrylate (EMA) are useful for imparting elasticity and other properties. The plate members can also be made from polyamide (nylon). Polyamides, polyesters, and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate are useful as dye carriers so the plate members can be various colors. Starch and other plant polymers are useful to increase biodegradability.

Where in the foregoing description reference has been made to elements or integers having known equivalents, then such equivalents are included as if they were individually set forth. Although the invention has been described by way of example and with reference to particular embodiments, it is to be understood that modifications and/or improvements may be made without departing from the scope of the invention as set out by the claims.

1. A reinforcement structure for securement to a corner of a sheet material, comprising:
a first plate member and a second plate member each having an overlapping portion; and
an aperture disposed within the overlapping portion,
wherein the apertures are coaxially aligned to accept a fastener at an axis on which the first and/or second plate members are rotatable to extend along adjacent edges of the sheet material in use.

2. The reinforcement structure according to claim 1, wherein the first plate member comprises an axially extending annular lip coaxial with the aperture of the first plate member, the lip extending at least partially into the aperture of the second plate member.

3. The reinforcement structure according to claim 1, wherein each plate comprises an upper plate and a lower plate and a slot there between for receiving the sheet material.

4. The reinforcement structure according to claim 1, wherein the fastener is a grommet or rivet, in use the grommet or rivet extending through each aperture to define a pivot about which the first or second plate rotates to meet adjacent edges of the sheet material.

5. The reinforcement structure according to claim 1, wherein the first and/or second plate members are rotatable to define an angle between them in the range of 0 degrees and 180 degrees.

6. The reinforcement structure according to claim 2, wherein the second plate member is rotatable on the lip relative to the first plate member.

7. The reinforcement structure according to claim 3, wherein the upper plate and the lower plate each comprise a said aperture, the apertures in the upper and lower plates coaxially aligned.

8. The reinforcement structure according to claim 7, wherein
the first plate member comprises an axially extending annular lip extending from the upper plate coaxial with the aperture of the upper plate, the lip received in the aperture of the upper plate of the second plate member, and
the second plate member comprises an axially extending annular lip extending from the lower plate coaxial with the aperture of the lower plate, the lip received in the aperture of the lower plate of the second plate member.

9. The reinforcing structure according to claim 8, wherein the annular lip of the first plate member extends upwards from the upper plate of the first plate member, and the annular lip of the second plate member extends downwards from the bottom plate of the second plate member.

10. The reinforcing structure according to claim 1, wherein the first and second plate members are identical, one of the first and second plate members being oriented upside-down relative to the other one of the first and second plate members so that the first and second plate members fit or assemble together.

11. The reinforcing structure according to claim 1, wherein the upper and lower plates of each of the first and second plate members are spaced apart by a backing wall, in use the backing wall abutting an edge of the sheet material.

12. The reinforcing structure according to claim 1, wherein the overlapping portion comprises a curved end, the upper and lower plate members each have a curved end in the overlapping portion, the curved end having a center of curvature at a center of the aperture.

13. The reinforcing structure according to claim 1, wherein the first or second plate members, or both, have a second aperture positioned at or towards an end opposite to the overlapping portion.

14. A sheet material with a reinforcement structure at a corner of the sheet material, the reinforcement structure comprising:
a first and a second plate member each having an overlapping portion and an aperture disposed in the overlapping portion, the apertures positioned in coaxial alignment; and
a fastener that extends through the apertures and the sheet material,
wherein the first and second plate members are rotatable about an axis through the apertures so that the first and second plate are positioned along edges of the sheet material that meet at the corner of the sheet material.

15. The sheet material according to claim 14, wherein the fastener is a grommet or rivet.

16. A plate member for use in construction of a reinforcement structure adapted for securement to a corner of sheet material comprising an aperture for coaxial configuration with an aperture of another elongate member, the aperture adapted to accept a fastener that extends through each coaxially aligned aperture at an axis about which the plate member can rotate relative to another plate member.

17. The plate member according to claim 16, wherein the plate member comprises an upper plate and a lower plate and a slit there between for receiving the sheet material.

18. The plate member according to claim 17, wherein the upper and lower plates are spaced apart by a backing wall and in use the backing wall abuts an edge of the sheet material.

19. The plate member according to claim 16, wherein the plate member comprises an axially extending lip coaxial with the aperture, the lip adapted to extend, at least partially, into the aperture of another axially aligned plate member.

20. The plate member according to claim 16, wherein plate member has a curved end, the curved end having a center of curvature at a center of the aperture.
